(19) United States
(12) Patent Application Publication
(10) Pub. No.: US 2007/0168992 A1
(43) Pub. Date: Jul. 19, 2007

(54) Method of tracing back the execution path in a debugger

(75) Inventor: Cary L. Bates, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/282,034

(22) Filed: Nov. 17, 2005

(51) Int. Cl. G06F 9/44

(52) U.S. Cl. 717/128

(57) ABSTRACT

A method, computer-readable medium, and system for tracing the execution path of a program are provided. In one embodiment, a control flow graph is created for the program. For each node in the control flow graph, a determination is made of whether the node has two or more predecessor nodes. For each node determined to have two or more predecessor nodes, a set instruction is inserted into program code corresponding to the predecessor node which sets a corresponding value of a variable. The corresponding value of the variable indicates that one or more instructions in the predecessor node were executed during an execution of the program.

### BACKGROUND OF THE INVENTION

1. Field of the Invention

The present invention generally relates to computers and computer software. More specifically, the invention is generally related to debugging software.

2. Description of the Related Art

Inherent in any software development technique is the potential for introducing “bugs”. A bug will typically cause unexpected results during the execution of the program. Locating, analyzing, and correcting bugs in a computer program is a process known as “debugging”. Debugging of programs may be either done manually or interactively by a debugging system mediated by a computer system. Manual debugging of a program requires a programmer to manually trace the logic flow of the program and the contents of memory elements, e.g., registers and variables. In the interactive debugging of programs, the program is executed under the control of a monitor program (known as a “debugger”), commonly located on and executed by the same computer system on which the program is executed.

An interactive high-level debugger typically operates at the program statement level, meaning that the program can be stepped through at the level of the source code. A “statement number mapping” is provided by the compiler of the source code to allow the debugger to determine which low-level machine instructions correspond to high-level program statements.

When debugging a program by tracing through program statements, the user often finds that the program has entered an unexpected state. For example, it may be that a variable has taken on an unexpected value, or the program has executed code that should not have been reached. Unless the user has been stepping through the program slowly and carefully, the chain of events causing the unexpected behavior to occur is not known. In such a case, the user needs to resolve how the program arrived at a particular program statement or how a particular variable took on an unexpected value.

In some cases, the user may insert a breakpoint into a program to assist the user in debugging the program. A breakpoint is inserted into the program code (e.g., at a line of code in the program) where the execution of the program is to stop. When the user executes the program and the breakpoint is triggered, the debugger may detect that the breakpoint was triggered, stop execution of the program, and allow the user to inspect the state of the program (e.g., where the program stopped and the values of variables in the program). Optionally, a user may use a “run to cursor” function in which the user places a cursor (e.g., a text cursor) at a line of code in the program and executes the “run to cursor” function. The function initiates the program and executes the program until the program execution beings executing the program. Execution of the program is halted when the program begins executing the code where the cursor is located. For the user, using breakpoints or a “run to cursor” function may incur costly overhead as the user determines where to insert the breakpoint or place the cursor in order to ensure that execution of the program stops at a point which is useful to the user.

In some cases, a user may also use a trace of the program to debug the program. The trace allows the user to stop a program at a given point in the program (e.g., at a breakpoint, exception, or trap) and determine which instructions were executed prior to reaching the current position (referred to as an execution path). By viewing the execution path, the user may determine the cause of any errors in the program. Such a trace may be useful where an unmonitored exception causes a debug stop to occur.

However, executing a trace may require extra overhead (e.g., execution time) to allow the trace to gather information about the program. For example, some traces may write a list of instructions to a file, causing a severe impact on performance of the program. The trace may be implemented by inserting extra instructions into the program which cause the program to write the list of instructions to the file. Thus, the extra inserted instructions may result in extra overhead (the time spent executing the inserted instructions) during execution of the program. For some programs, executing such a trace may be too invasive from a performance and memory perspective to use such a trace to debug the program.

Therefore there is a need for an improved system, computer-readable medium, and method of determining the execution path of a program.

### SUMMARY OF THE INVENTION

The present invention generally provides a system, computer-readable medium, and method of determining the execution path of a program. In one embodiment, the method includes creating a control flow graph for the program. For each node in the control flow graph, a determination is made of whether the node has two or more predecessor nodes. For each node determined to have two or more predecessor nodes, a set instruction is inserted into program code corresponding to the predecessor node which sets a corresponding value of a variable. The corresponding value of the variable indicates that one or more instructions in the predecessor node were executed during an execution of the program.

In one embodiment, a tangible computer-readable medium containing a program product is provided. When executed by a processor, the program product performs an operation which includes creating a control flow graph for a program. For each node in the control flow graph, a determination is made of whether the node has two or more predecessor nodes. For each node determined to have two or more predecessor nodes, a set instruction is inserted into program code corresponding to the predecessor node which sets a corresponding value of a variable. The corresponding value of the variable indicates that one or more instructions in the predecessor node were executed during an execution of the program.

In one embodiment, a system including a processor and a memory is provided. The memory contains a program product, which, when executed by the processor, performs an operation. The operation includes creating a control flow graph for a program. For each node in the control flow graph, a determination is made of whether the node has two or more predecessor nodes. For each node determined to have two or more predecessor nodes, a set instruction is inserted into program code corresponding to the predecessor node which sets a corresponding value of a variable. The corresponding value of the variable indicates that one or more instructions in the predecessor node were executed during an execution of the program.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a computer system according to one embodiment of the present invention.

FIG. 2 is a block diagram depicting contents of a debug information file according to one embodiment of the invention.

FIGS. 3A-3C depict a control flow graph, sample source code, and sample machine instructions according to one embodiment of the invention.

FIGS. 4A and 4B depict a process for compiling a program according to one embodiment of the invention.

FIGS. 5A and 5B depict a process for displaying the execution path of a program according to one embodiment of the invention.

FIG. 6 is a screen diagram depicting a graphical user interface according to one embodiment of the invention.

FIG. 7 is a control flow graph according to one embodiment of the invention.

FIGS. 8A and 8B depict a flow diagram and sample source code according to one embodiment of the invention.

FIGS. 9A and 9B depict a process for displaying the execution path of a program according to one embodiment of the invention.

FIG. 10 is a screen diagram depicting a graphical user interface according to one embodiment of the invention.

### DETAILED DESCRIPTION OF THE PREFERRED EMBODIMENTS

The present invention generally provides a method, apparatus and article of manufacture for debugging computer programs. In general, debugging computer programs is aided by allowing a user to trace the execution path of the program prior to a stop point in the program. In one embodiment, a control flow graph is created for the program. For each node in the control flow graph, a determination is made of whether the node has two or more predecessor nodes. For each node determined to have two or more predecessor nodes, a set instruction is inserted into program code corresponding to the predecessor node which sets a corresponding value of a variable. The corresponding value of the variable indicates that one or more instructions in the predecessor node were executed during an execution of the program. Thus, embodiments of the invention allow program statements which were executed prior to a stop position indicate to the user how execution of the program was performed.

Embodiments of the invention may be implemented as a program, for example, comprising program modules. The program modules that define the functions of the present embodiments may be placed on a signal-bearing medium. The signal-bearing media include, but are not limited to, (i) information permanently stored on non-writable storage media, (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, object, module or sequence of instructions will be referred to herein as computer programs, or simply programs. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention.

### System Overview

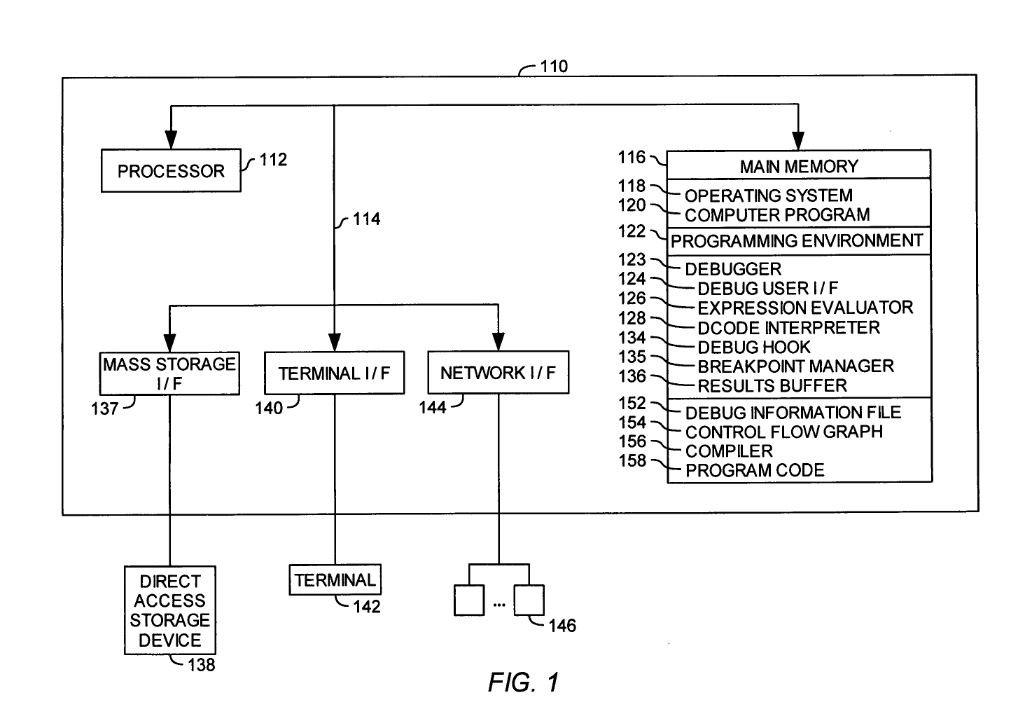

A particular system for implementing the present embodiments is described with reference to FIG. 1. However, those skilled in the art will appreciate that embodiments may be practiced with any variety of computer system configurations including hand-held devices, multiprocessor systems, microprocessor-based or programmable consumer electronics, minicomputers, mainframe computers and the like. The embodiment may also be practiced in distributed computing environments where tasks are performed by remote processing devices that are linked through a communications network. In a distributed computing environment, program modules may be located in both local and remote memory storage devices.

In addition, various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

FIG. 1 depicts a computer system 110 according to one embodiment of the present invention. For purposes of the invention, computer system 110 may represent any type of computer, computer system or other programmable electronic device, including a client computer, a server computer, a portable computer, an embedded controller, etc. The computer system 110 may be a standalone device or networked into a larger system.

The computer system 110 may include a mass storage interface 137 operably connected to a direct access storage device 138, a video interface 140 operably connected to a display 142, and a network interface 144 operably connected to a plurality of networked devices 146. The display 142 may be any video output device for outputting a user interface. The networked devices 146 could be desktop or PC-based computers, workstations, network terminals, or other networked computer systems.

Computer system 110 is shown for a programming environment that includes at least one processor 112, which obtains instructions, or operation codes, (also known as opcodes) and data via a bus 114 from a main memory 116. The processor 112 could be any processor adapted to support the debugging methods, apparatus and article of manufacture of the invention. In particular, the computer processor 112 is selected to support monitoring of memory accesses according to user-issued commands.

The main memory 116 could be one or a combination of memory devices, including Random Access Memory, nonvolatile or backup memory (e.g., programmable or Flash memories, read-only memories, etc.). In addition, memory 116 may be considered to include memory physically located elsewhere in a computer system 110, for example, any storage capacity used as virtual memory or stored on a mass storage device or on another computer coupled to the computer system 110 via bus 114.

The main memory 116 includes an operating system 118, a computer program 120 (to be debugged), and a programming environment 122 comprising a debugger program 123, debug information file 152, Control Flow Graph (CFG) 154, compiler 156, and program code 158 The programming environment 122 facilitates debugging the computer program 120, or computer code, by providing tools for locating, analyzing and correcting faults.

### Compiler and Debugger Overview

Program code 158 may include programming instructions, for example, in a high-level computer programming language. Compiler 156 may analyze and process the program code 158 to generate the machine-executable instructions for computer program 120 (referred to as compiling). In some cases, in addition to generating machine instructions which implement the program code 158, the compiler 156 may also insert machine instructions into the program 120 which implement debugging features. In some cases, the desired debugging features may be selected and enabled by setting one or more compiler options or flags in the compiler 156. Optionally, the debugging features may always be present in the generated computer program 120, or the debugging features may be present where the compiler 156 is placed in a debugging mode.

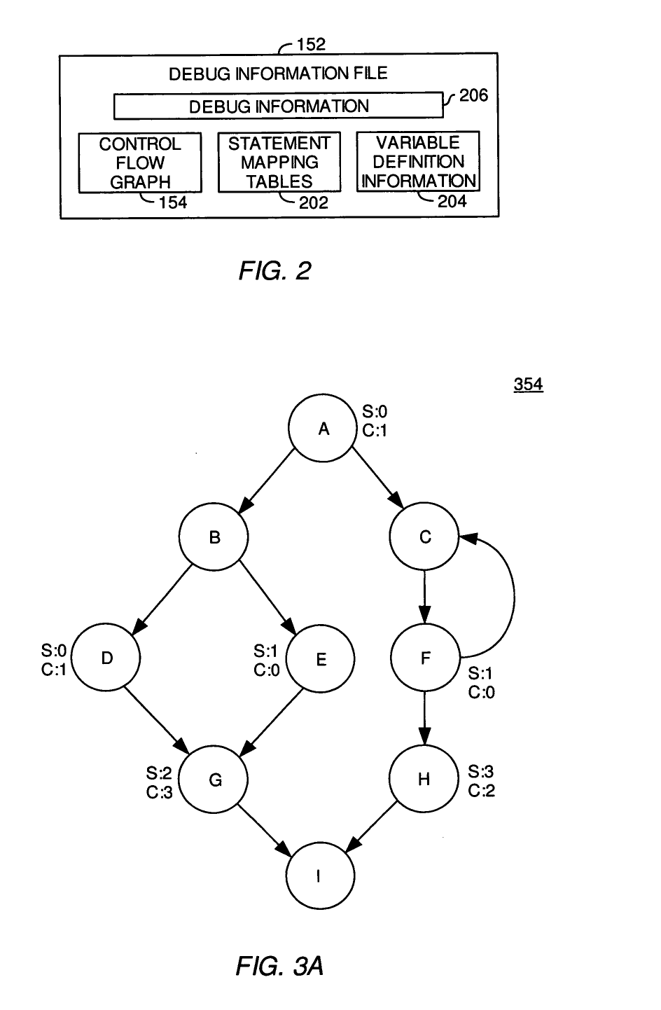

The compiler 156 may also be used to generate all or part of the debug information file 152 during compilation. FIG. 2 depicts the contents of the debug information file 152 according to one embodiment of the invention. The debug information file 152 may include control flow graph 154, statement mapping tables 202, variable definition information 204, and other debug information 206, each of which may be used by the debugger 123 as described below in greater detail.

In one embodiment, the debugger 123 comprises a debugger user interface 124, expression evaluator 126, Dcode interpreter 128 (also referred to herein as the debug interpreter 128), debugger hook 134, a breakpoint manager 135 and a result buffer 136. Although treated herein as integral parts of the debugger 123, one or more of the foregoing components may exist separately in the computer system 110. Further, the debugger 123 may include additional components not shown.

In one embodiment, the debugging process may be managed using the debug user interface 124. In some cases the debug user interface 124 may be initiated by a user who wishes to debug a program. Once initiated, the debug user interface 124 may be used to initiate the program 120 being debugged. Optionally, the debugger 123 may be initiated by the program 120, for example, through code inserted into the program 120 by the compiler 156. Optionally, a development environment may be used to launch and manage the compiler 156, debugger 123, and other programs used for program development.

The debugger user interface 124 may be used to present the program code 158 being debugged. In some cases, where the program 120 is executed and then passes control to the debugger 123, the debugger 123 may highlight the current line of the program 120, for example, on which a stop or error occurs. The user interface 124 may also allow the user to set control points (e.g., breakpoints and watch points), display and change variable values, and activate other features described herein by inputting the appropriate commands.

The expression evaluator 126 may parse the debugger commands passed from the user interface 124 and use a data structure (e.g., a table) generated by the compiler 156 to map the line number in the debugger commands to the physical memory addresses in memory 116. In addition, the expression evaluator 126 may be used to generate a Dcode program for commands entered by the user. The Dcode program may be machine executable language that implements the commands.

The Dcode generated by the expression evaluator 126 may be executed by the Dcode interpreter 128. The interpreter 128 handles expressions and Dcode instructions to perform various debugging steps. Results from Dcode interpreter 128 may be returned to the user interface 124 through the expression evaluator 126. In addition, the Dcode interpreter 128 may pass information to the debug hook 134, which takes steps described below.

In some cases, after entering debug commands, the user may provide an input that begins or resumes execution of the program 120. During execution, control may be returned to the debugger 123 via the debug hook 134. The debug hook 134 is a code segment that returns control to the appropriate user interface, for example, where execution of the program 120 results in an event causing a trap to fire (e.g., where a breakpoint is encountered). Control may then returned to the debugger 123 by the debug hook 134 and program execution may be halted. The debug hook 134 may then invoke the debug user interface 124 and may pass the results to the user interface 124. In some cases, the user may input commands while the program 120 is stopped causing the debugger 123 to run a desired debugging routine. Result values may then be provided to the user via the user interface 124.

### Constructing a Control Flow Graph

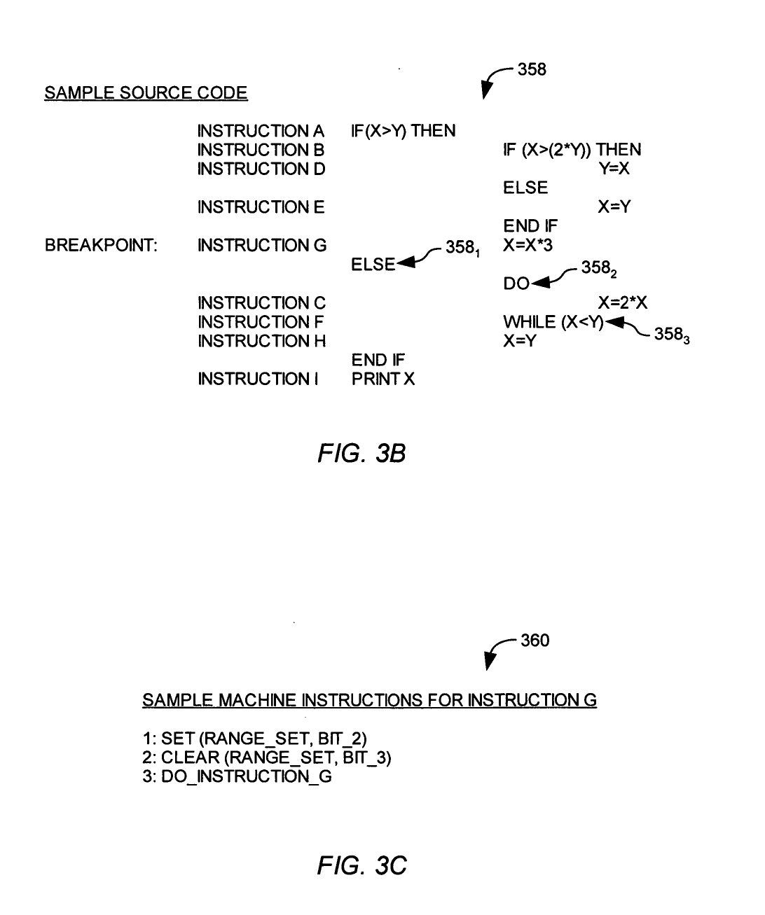

In one embodiment of the invention, a control flow graph 154 may be created for the computer program 120 by compiling the program code 158. FIG. 3A depicts a CFG 354 according to one embodiment of the invention.

In general, the CFG 354 contains nodes which represent blocks of machine-executable computer instructions. As described above, the machine-executable instructions may be constructed during the compilation of computer program 120 by the compiler 156. A basic block is a sequence of consecutive machine-executable instructions in which flow of control enters at the beginning and leaves at the end without halt or the possibility of branching except at the end. Each block may contain one or more high-level computer instructions, as well as one or more machine executable computer instructions. Optionally, a single CFG 154 may span multiple routines in the program 120.

As depicted, the CFG 354 may contain nodes A-I. During compilation, the compiler 156 may construct the debug information file 152 which includes the CFG 354. The compiler 156 may construct the debug information file, for example, using source code such as sample source code 358 depicted in FIG. 3B. As depicted, sample source code 358 includes several high-level computer instructions, including instructions A-I. Instruction A is an “if . . . then . . . else” statement. If the condition depicted (x>y) is satisfied, the instruction may execute the next consecutive statement (instruction B) in the sample source code. Optionally, if the condition is not satisfied, the instruction may execute statements beginning at the corresponding “else” statement 3581 (e.g., at instruction C).

Thus, after instruction A is executed, either instruction B or instruction C may be executed next. Accordingly, as depicted in the CFG 354, node A may branch to either node B or node C. Node A may be referred to as the parent or predecessor node of node B and node C, and node B and node C may be referred to as the child nodes of node A.

The “do . . . while” loop 358₂, 358₃ may be executed at least once irrespective of the values of the variables “x” and “y” before the exit condition for the loop is tested. When executed, if the variable “x” is not greater than the variable “y”, the “do . . . while” loop 358₂, 358₃ may be executed again. Execution of the “do . . . while” statement (which includes instruction C) may continue until the condition (x<y) in instruction F is not satisfied. Because the “do . . . while” 358₂, 358₃ loop is executed at least once, instruction C may be executed at least once. Also, because the “while” statement 358₃ may either jump back to the do statement 3582 and execute instruction C again, or continue executing at instruction H, node F depicted in CFG 354 may have branches to node C and node H. After instruction H is executed, execution may continue at node I.

Similarly, with respect to instruction B, instruction B may be an “if . . . then . . . else” statement similar to instruction A. Instruction B may either jump to instruction D or instruction E, each of which may continue execution at instruction G. Thus, node B in the CFG 354 branches to nodes D and E and nodes D and E branch to node G. After instruction G is executed, execution may continue at instruction I. Thus, node G may branch to node I.

While described above with respect to a single node corresponding to a single instruction, each node may have several instructions. Also, in some cases, the nodes and interconnections may be selected in a manner other than as depicted in FIG. 3A. For example, because instruction I is always executed after instruction H, node H may be removed and node F may be connected directly to node I, and node I may logically be said to contain instruction H. Thus, nodes may be allocated on a per-branch basis, or, optionally, on a per-instruction basis. Other node allocations may be implemented as desired and as known to those skilled in the art.

### Recording the Execution Path of the Program

In one embodiment of the invention, the CFG 354 may be used in conjunction with a variable (referred to herein as the path variable) which is automatically inserted into the program 120 by compiler 156 to record the execution path of the program 120. For each node in the control flow graph 354 with two or more predecessor nodes, one or more statements recording which predecessor node was most recently executed by the program before reaching the node may be inserted into the program 120. The statements may record the executed predecessor node in one or more bits of the path variable inserted into the program 120.

As an example, when the compiler 156 is initiated, the compiler 156 may generate the path variable as an integer, long integer, or other type of variable within the program 120. Where a CFG 354 is used for each routine, the path variable may be inserted into each routine for each CFG 354. Optionally, the variable may be allocated as a global variable.

In one embodiment, the compiler 156 may examine the CFG 354 for each routine in the program 120 and assign bits within the path variable. Each bit assigned may correspond to a node in the CFG 354. When the debugger 123 is stopped at a particular statement, it may look at the value of the path variable and determine which statements were executed prior to reaching the current statement. Thus, the debugger 123 may be able to determine the execution path of the program 120.

In one embodiment, the recorded length of the execution path may depend on the size of the path variable inserted. To record longer execution paths, larger variables may be inserted into the program 120. Where each CFG 354 corresponds to a routine of the program 120 and where a separate variable is used for each routine, different variable sizes may be utilized, wherein the variable size is chosen according to the length of the routine (e.g., the number of instructions). Optionally, as described below, bits within the variable may be reused when every bit in the variable is full.

As described above, the compiler 158 may insert additional instructions into the program 120 to record the execution path of the program 120 in the path variable. In one embodiment, the compiler 158 may utilize a predecessor set and range set in conjunction with the CFG 354 to determine where to insert the additional instructions and to determine how the instructions should manipulate the path variable. The predecessor set may be used to determine the predecessor(s) for each node in the CFG 354. Thus, the predecessor set for node G, for example, contains nodes D and E (represented using set notation as {D, E}, meaning nodes D and E are predecessor nodes for node G).

In one embodiment, the range set is a set of all the bit positions in the path variable that have been used by any of the predecessors in a given predecessor set. For example, if predecessor node E of the predecessor set {D, E}, defined above, uses bits 0 and 1 in the path variable to record the execution path, the range set for the predecessor node E may be {1}, indicating that bit 1 is taken. Thus, the range set may be used by the compiler 158 to allocate bit positions for recording the execution path without overwriting any bit positions which are already being used by other predecessor nodes. Allocation of the bit positions is described in greater detail below in greater detail below.

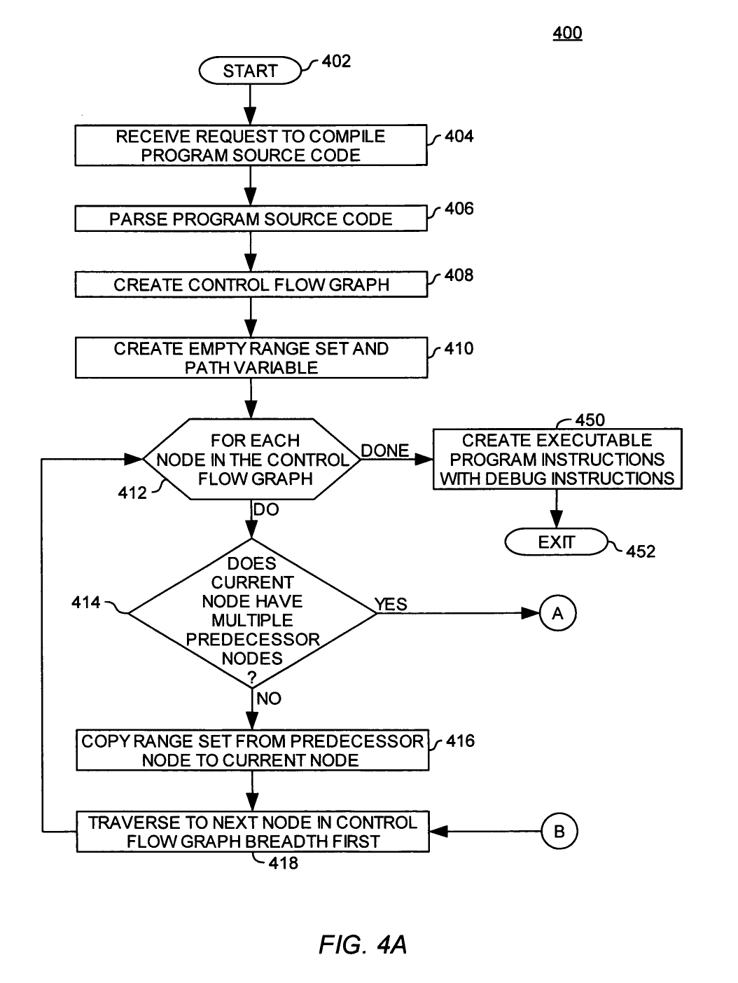

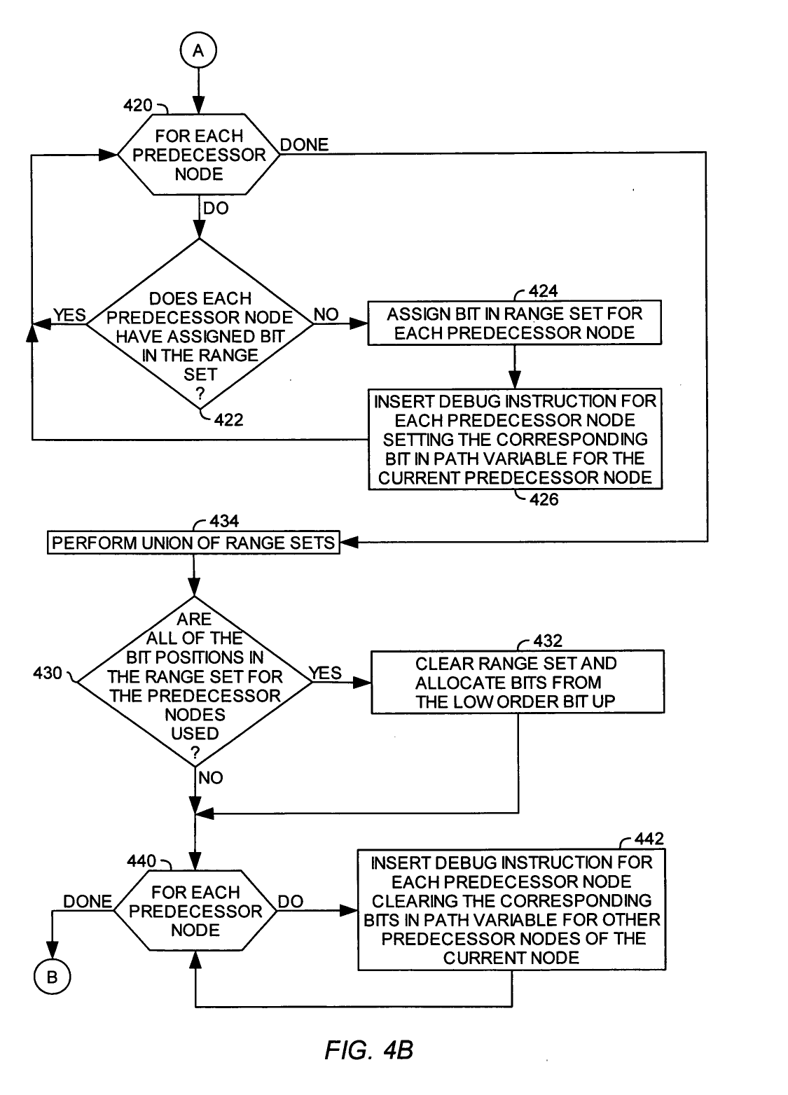

FIGS. 4A and 4B depict a process 400 for compiling a program according to one embodiment of the invention. The process 400 may begin at step 402. At step 404, a request to compile program source code may be received. For example, a user may request that source code 358 be compiled using compiler 156. At step 406, the program source code may be parsed. At step 408, a CFG 354 may be created, and at step 410, an empty range set (e.g., R={null}) for the CFG 354 and path variable may be created.

At step 412, a loop may begin which continues for each node in the CFG 354. Thus, for the CFG 354 depicted in FIG. 3A, the loop may begin with Node A. At step 414, a determination may be made of whether the current node has multiple predecessor nodes. If the current node does not have multiple predecessor nodes (e.g., Node A has no predecessors), then the process 400 may continue to step 416 where the range set from the predecessor node (which, for Node A, is null) is copied to the current node. At step 418, the loop may traverse to the next node in the CFG 354 using a breadth first traversal (a breadth first traversal moves downward and to the right for each level down, e.g., for CFG 354, A, B, C, D, E, F, G, H, I is a breadth first traversal).

If, at step 414, a determination is made that the current node does have multiple predecessors (e.g., Node C has predecessors of Node A and Node F), the process 400 may continue to step 420 where a loop is entered which is repeated for each predecessor node of the current node. At step 422, a determination is made of whether the current predecessor node has already been assigned a bit in the range set. If the predecessor node has an assigned bit in the range set, then the loop may continue with the next predecessor node at step 420.

If, however, the current predecessor node does not have an assigned bit in the range set, then a bit in the range set may be assigned at step 424. For example, with respect to Node C, the predecessor nodes are Node A and Node F. The range set is initially empty (e.g., because Node C is the first node in the traversal which has multiple predecessors). Thus, the range set for Node C is R={null} and the bits for each predecessor node may be assigned to the first free bit in the range set, beginning with bits 0 and 1. Bits 0 and 1 are assigned because they are the first positions free in the range set. Thus, on the first iteration of loop 420, Node A will be assigned bit 0 and on the second iteration of loop 420 Node F will be assigned bit 1. After the bits are assigned, the range set for Node C will be set at step 434 and will become R={0, 1}, indicating that bits 0 and 1 have been assigned.

After the node has been assigned a bit in the range set, at step 426 a debug instruction may be inserted for each predecessor node setting the corresponding bit in the path variable for that predecessor node. For example, an instruction may be inserted into the code for Node A which sets bit 0 in the path variable (depicted in FIG. 3A as “S: 0”). In one embodiment, each set instruction may be a single OR instruction (e.g., an instruction which performs a Boolean “OR” of the path variable and a mask). For example, to set bit 0 in a 4-bit path variable, the OR instruction may perform a Boolean “OR” of the path variable with a mask of b0001 (e.g., “OR Range_Set, b0001” where the “1” will set bit 0). Similarly, an instruction may be inserted into the code for Node F which sets bit 1 in the path variable (e.g., “OR Range_Set, b0010” where the “1” will set bit 1). By setting the bit in the path variable, the execution path of the program 120 may be determined by examining the path variable. By examining the bits set in the path variable, the predecessor nodes of the current node (e.g., Node C) which were previously executed may be determined. For example, when the code for node A is executed, bit 0 in the path variable may be set to a ‘1’. If the program 120 later stops at a portion of the program 120 corresponding to Node C, the path variable may be examined. Because bit 0 is set to ‘1’ in the path variable, it may be determined that the instructions corresponding to Node A were the instructions which were executed prior to the execution of the instructions for Node C.

After each predecessor node has been examined in the loop beginning at step 420, the process 400 may continue at step 424 where a union of all range sets is produced to become the range set for the current node (in this case, Node C). Process 400 then continues to step 430 where a determination is made of whether all of the bit positions in the range set computed above are used. If all of the bits in the range set for the current node are used, the range set may be cleared at step 432 so that new bits may be allocated from the low order bit up. If however, all of the bits in the range set for the current node are not used, the range set for the current node is unaltered. For example, with respect to Node I, the range set for Node G is R={0, 1} and the range set for Node H is R={0, 1}. Thus, the union of the range sets is R={0, 1} and bits in the range set for Nodes G and H will be allocated beginning with bit 2 and bit 3, respectively.

In some cases (e.g., where a program contains loops), multiple predecessor nodes for a given node may be executed. For example, with respect to Node C, Node A, Node C, and Node F may be executed. Then, the program execution may loop from Node F back to Node C. Thus, because both Node A and Node F set bits in the path variable, the path variable may indicate that both Node A and Node F are predecessor nodes for Node C. Optionally, in one embodiment, to determine the most recently executed predecessor node for an instruction, one or more instructions may be inserted into the program 120 which clear bits in the path variable.

For example, at step 440, a loop may begin which continues for each predecessor node of the current node. In the loop, at step 442, a debug instruction may be inserted into each predecessor node which clears bits in the path variable for other direct predecessor nodes of the current node. By clearing the bits in the path variable for other direct predecessor nodes, the most recently executed node in the execution path may be determined. For example, with respect to node C, the predecessor nodes modified will be Nodes A and C. With respect to Node A, an instruction may be inserted into the program 120 which clears bits in the path variable for Node C's other predecessor node, Node F (e.g., bit 1 in the path variable may be cleared as indicated by the “C: 1” next to Node A in FIG. 3A).

In one embodiment, each clear instruction may be a single AND instruction (e.g., an instruction which performs a Boolean “AND” of the path variable and a mask). For example, to clear bit 1 in a 4-bit path variable, the AND instruction may perform a Boolean “AND” of the path variable with a mask of b1101 (e.g., “AND Range_Set, b1101” where the “0” will clear bit 1). When Node A is executed, the bit in the path variable corresponding to Node F will be cleared and the bit in the path variable corresponding to Node A will be set. If the program 120 is halted at Node C after executing Node A, the set bit for Node A and the cleared bit for Node F will indicate that Node A was the most recently executed predecessor node for Node C.

Similarly, with respect to Node F, at step 442 an instruction (e.g., “AND Range_Set, b1110” where the “0” will clear bit 0) may be inserted into the program 120 which clears bits in the path variable for Node A (indicated by the “C: 0” next to node F in FIG. 3A). When Node F is executed, the bit in the path variable corresponding to Node A will be cleared, and the bit in the path variable corresponding to Node F will be set. If the program 120 is halted at Node C after executing Node F, the set bit for Node F and the cleared bit for Node A will indicate that Node F was the most recently executed predecessor node for Node C.

After each predecessor node for the current node has been examined in the loop beginning at step 440, the process 400 may continue by traversing breadth-first to the next node in the CFG 354. After each node in the CFG 354 has been examined in the loop beginning at step 412, executable program instructions with debug instructions may be created at step 450. The process 400 may then exit at step 452.

FIG. 3C is a pseudo-code listing which depicts sample machine instructions inserted into the program code for a node (Node G) to track the execution path of the program 120 according to one embodiment of the invention. As depicted, an instruction setting bit 2 in the path variable (Range_Set) is inserted at line 1. As described above, setting bit 2 may indicate that Node G is the most recently executed node in the CFG 354. Also, an instruction clearing bit 3 may be inserted at line 2. Clearing bit 3 may indicate that Node H was not the most recently executed node in the CFG 354. Finally, at line 3, machine instructions for Node G may be inserted (“Do_Instruction_G”). As described above, in some cases, a node may contain multiple machine instructions as well as multiple higher level program instructions.

In one embodiment of the invention, the set and clear instructions may be inserted after the machine instructions for the node (e.g., after Instruction G for Node G). Placing the set and clear instructions after the program instructions for a node may correspond to performing the set and clear on the arcs of the CFG 354 instead of at the nodes. Where set and clear instructions are placed after the instructions for a node (e.g., after the branch instruction which branches to another node), an additional branch instruction (e.g., to branch from the set and clear instructions to the target of the arc) may be inserted into the program 120.

### Displaying the Execution Path of a Program

In one embodiment of the invention, the bits in the path variable may be used to determine the execution path of the program 120. In general, after the program 120 is initialized and comes to a halt within one of the nodes in the CFG 354 (e.g., due to a breakpoint, exception, or trap), the one or more bits in the variable for the path variable may be used to determine the predecessor nodes for the node at which the program halts. When the program 120 comes to a halt, one or more instructions corresponding to nodes in the CFG 354 may be depicted. If a bit corresponding to a given node is set in the path variable, then the one or more instructions corresponding to that node may be graphically indicated, e.g., by highlighting the text of the instruction, placing a graphical marker next to the one or more corresponding instructions, numbering the instructions according to the order of execution, bolding or italicizing the instruction text, by placing an icon next to the instruction, or by indicating the instructions in any other appropriate manner.

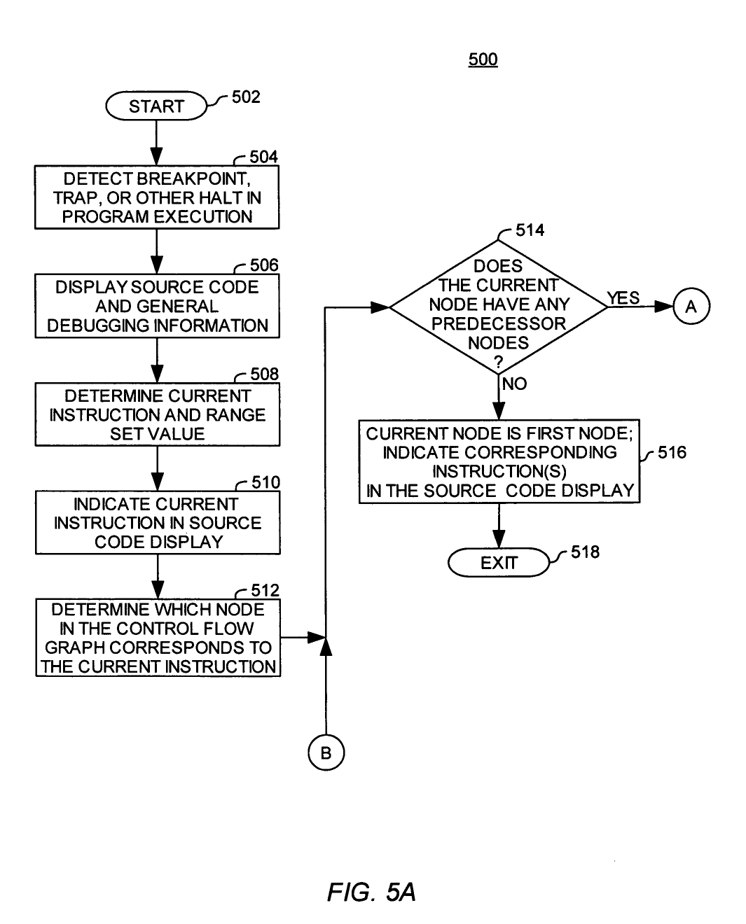

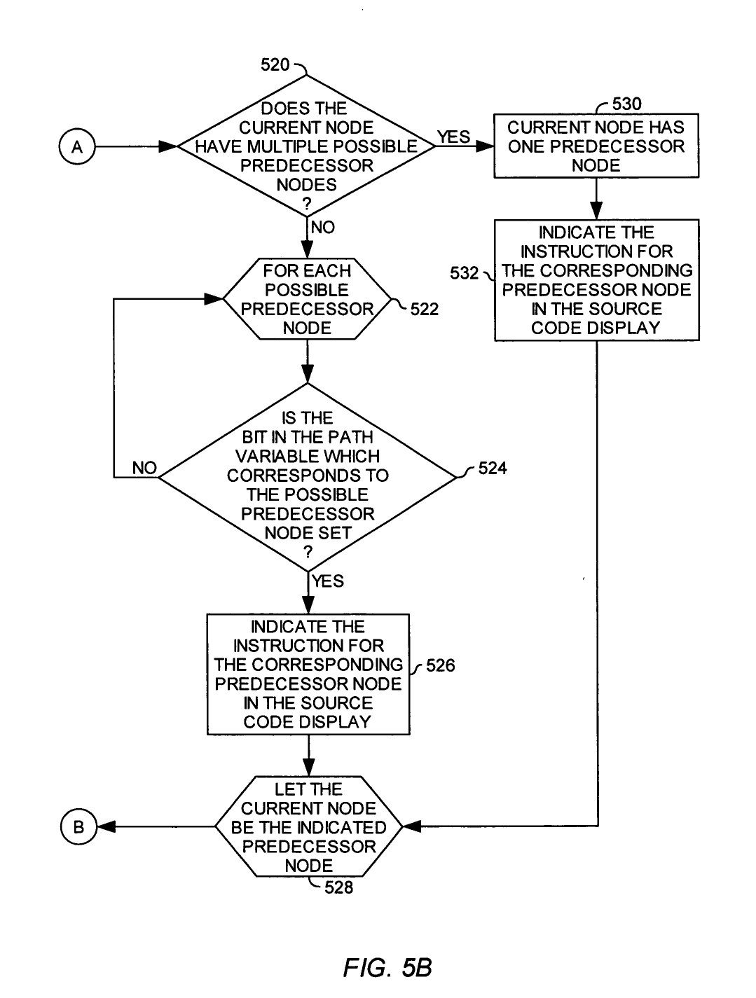

FIGS. 5A and 5B depict a process 500 for displaying an execution path of the program 120 according to one embodiment of the invention. The process 500 may begin at step 502 and continue to step 504 where a breakpoint, trap, or other halt in program execution is detected. When execution of the program 120 halts, control may be passed to the debugger 123 which may be used to process the breakpoint, trap, or other reason for halting program execution.

At step 506, the source code 158 and other general debugging information may be displayed. At step 508, the current instruction (e.g., the instruction at which execution halted) may be determined as well as the value of the path variable. The current instruction may be determined, for example, by using the address at which the program 120 halts as a lookup in the statement mapping tables 202 in the debug information file 152. At step 510, the current instruction may be indicated in the source code display, for example, by highlighting the instruction. Then at step 512, the CFG 354 may be used to determine which node in the CFG 354 corresponds to the current instruction in the program 120 (e.g., the instruction at which program execution halted).

After step 512, the process 500 may enter a loop which continues for each node in the CFG 354. At step 514, a determination may be made of whether the current node has any predecessor nodes. If the current node does not have any predecessor nodes (e.g., like Node A), the current node is the first node in the CFG 354 and the instructions corresponding to the first node may be indicated in the source code display at step 516. The process 500 may then terminate at step 518. If, however, a determination is made at step 514 that the current node has predecessor nodes, the process 500 may continue at step 520 where a determination is made of whether the current node has multiple possible predecessor nodes. If the current node does not have multiple predecessor nodes, then the current node has one predecessor node (step 530) and the instructions corresponding to the one predecessor node may be indicated in the source code display at step 532.

If, however, a determination is made at step 520 that the current node has multiple possible predecessor nodes, a loop may be entered at step 522 which continues for each possible predecessor node. At step 524 a determination may be made of whether the bit in the path variable which corresponds to the possible predecessor node is set. If the bit corresponding to the predecessor node being examined is not set, the loop may continue by examining the next possible predecessor node at step 522. If, however, the bit in the path variable which corresponds to the possible predecessor node is set, the possible predecessor node is actually the previously taken predecessor node and the instructions corresponding to the actual predecessor node may be indicated in the source code display at step 526.

Then, at step 528, the current node may become the indicated predecessor node and the process 500 may continue by examining the current node as described above.

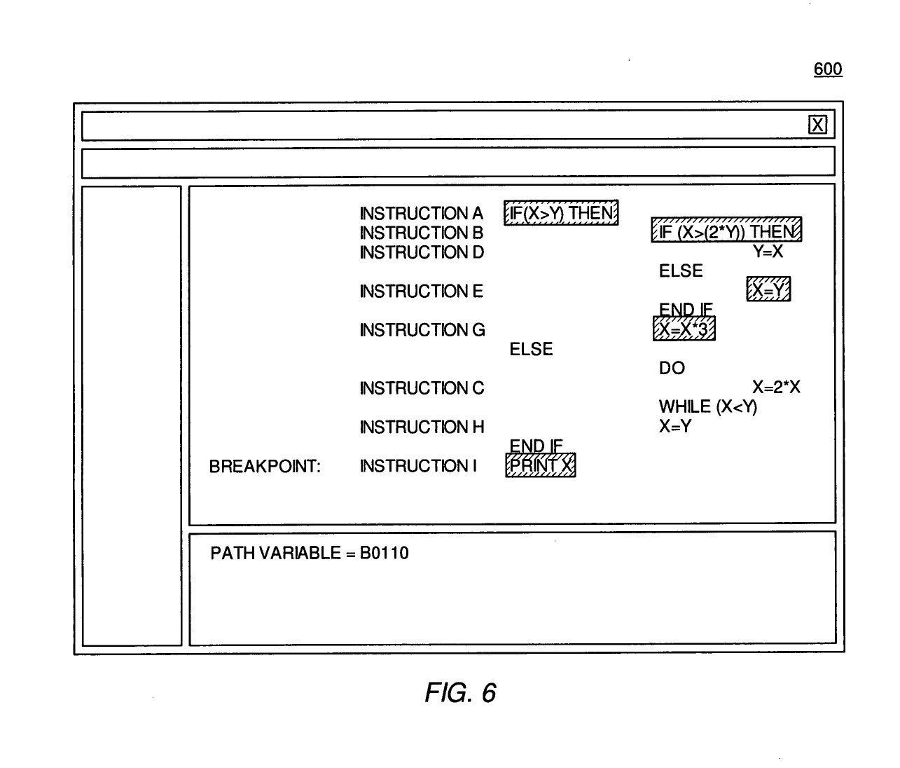

FIG. 6 is a diagram depicting a graphical user interface (GUI 600) according to one embodiment of the invention. The GUI 600 may result, for example, from process 500. As depicted, a breakpoint may be inserted into the program 120 as Instruction I (which corresponds to Node I). When the program 120 halts at instruction I due to the breakpoint, the sample source code 358 for the program 120 may be displayed. In some cases, the path variable may also be displayed. As an example, the path variable value may be the binary number 0110 (as indicated by the statement “Path Variable=b0110”).

In one embodiment, highlighting of executed instructions may be used to identify the execution path of the program 120 in the debugger 123. Because the program 120 has stopped at Node I, the corresponding instruction(s) for Node I (Instruction I) may be highlighted. Also, because bit 2 in the path variable (the third bit from the right in b0110) is set, the debugger 123 may determine that Node G is the predecessor node for Node I. Accordingly, the instruction(s) corresponding to Node G (Instruction G) may be highlighted. Furthermore, because bit 1 in the path variable (the second bit from the right in b0110) is set, the debugger 123 may determine that Node E is the predecessor node for Node G. Accordingly, the instruction(s) corresponding to Node E (Instruction E) may be highlighted. With respect to Node E, the only possible predecessor node for Node E is Node B, and the only possible predecessor node for Node B is Node A. Accordingly, the instruction(s) corresponding to Node B and Node A (Instruction B and Instruction A) may be highlighted.

Thus, as depicted, the path variable may be used to quickly determine the execution path of the program 120. Because two instructions a set instruction and a clear instruction (which may be implemented, for example, by an “OR” instruction and an “AND” instruction), are used to maintain the variable which tracks the execution path, the overhead (e.g., processor cycles) used to track the execution path may be minimal.

### Further Embodiments and Examples

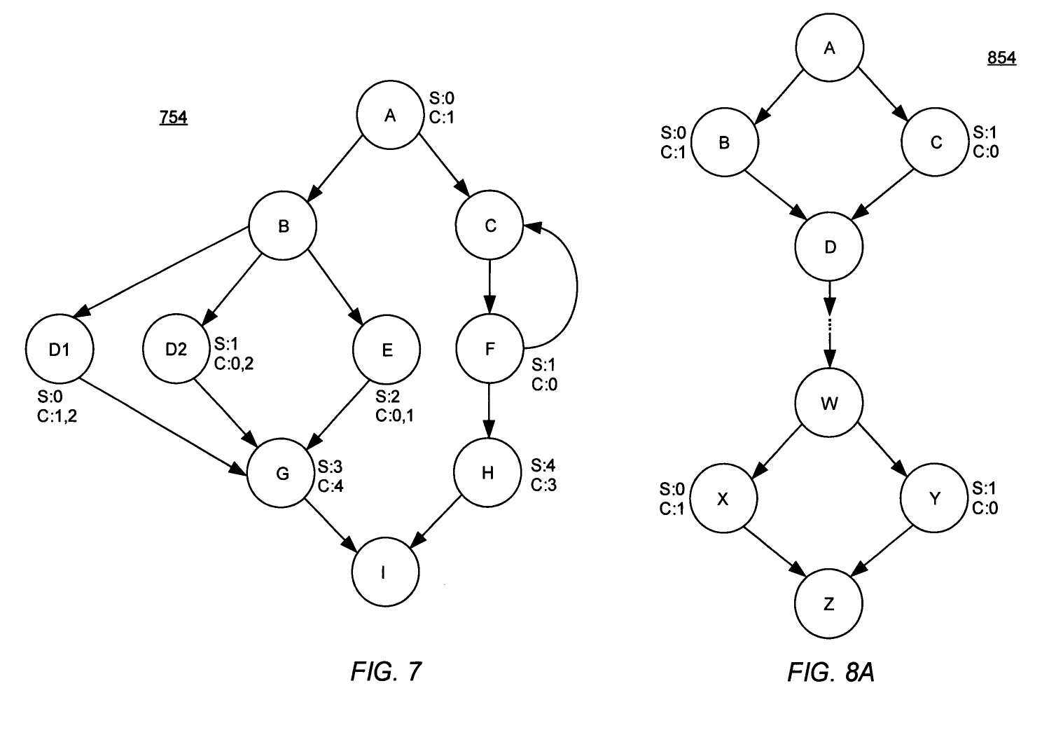

In one embodiment of the invention, an instruction may be inserted into a node which clears multiple bits in the variable which tracks the execution path of the program 120. For example, with respect to the CFG 754 depicted in FIG. 7, the instructions in Node B may include a statement which branches to an instruction in Node D1, D2, or E. The assigned range set for Node G may be R={0, 1, 2} with bit 0 in the variable corresponding to Node D1, bit 1 corresponding to Node D2, and bit 2 corresponding to Node E. As depicted, an instruction may also be inserted for Node D1 which clears bits 1 and 2 for Nodes D2 and E. By clearing bits 1 and 2, Node D1 may be identified as the most recently executed predecessor node for Node G. Similarly, instructions may be inserted for Node D2 clearing bits 0 and 2 and for Node E clearing bits 0 and 1, thereby ensuring that the most recently executed predecessor node for Node G may determined by examining the path variable.

Furthermore, with respect to Node I in FIG. 7, the range set for the predecessor Node G is R={0, 1, 2} and the range set for the predecessor Node H is R={0, 1}. Accordingly, the initial range set for Node I is the union of the range sets for Nodes G and H, R={0, 1, 2}. Accordingly, when bits in the range set are allocated for predecessor nodes G and H, the next available bits (bits 3 and 4, respectively) may be used.

In some cases, where a single variable is used to track the execution path of the program 120, the number of bits in the variable, and thus the number of nodes tracked by the variable, is limited. In one embodiment, a special graphical indicator (e.g., a special icon or highlighting) may be used where the execution path of the program 120 cannot be determined.

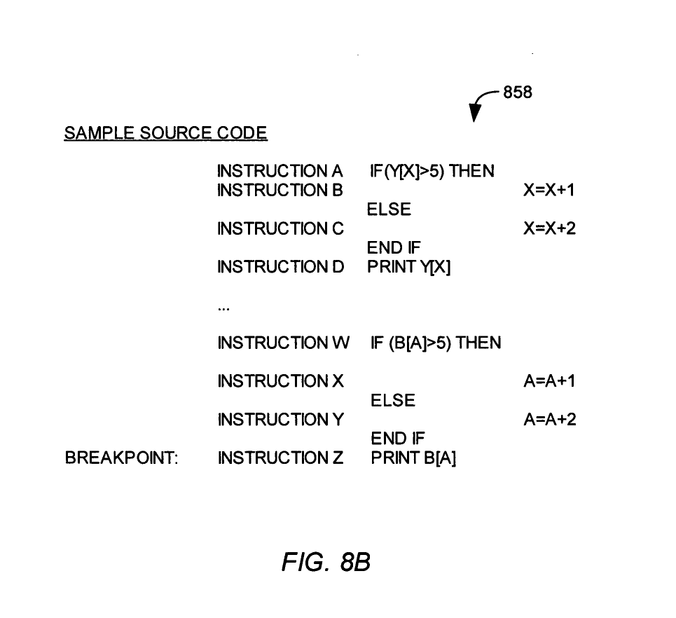

FIG. 8A is a diagram depicting an exemplary CFG 854 in which the execution path of the program 120 may become indeterminate and FIG. 8B is a source code depicting exemplary instructions corresponding to the CFG 854 according to one embodiment of the invention. As depicted in FIG. 8A, the CFG 854 may contain a first group of nodes (A, B, C, and D). In the first group of node, bits 0 and 1 in the path variable may be used to determine whether Node B or Node C, respectively, is the most recently executed predecessor of Node D. At a later point in the program 120, bits 0 and 1 may be reused to track the execution path of the program 120 through a second group of nodes (W, X, Y, and Z). As depicted, bits 0 and 1 in the path variable may be used to determine whether Node X or Node Y, respectively, is the most recently executed predecessor node of Node Z. If program execution is halted at Node Z, e.g., due to a breakpoint set at Instruction Z, bits 0 and 1 may be used to determine the most recently executed predecessor for Node Z, but because the bits used to track Node B and Node C have been overwritten, bits 0 and 1 may not be used to determine the most recently executed predecessor for Node D.

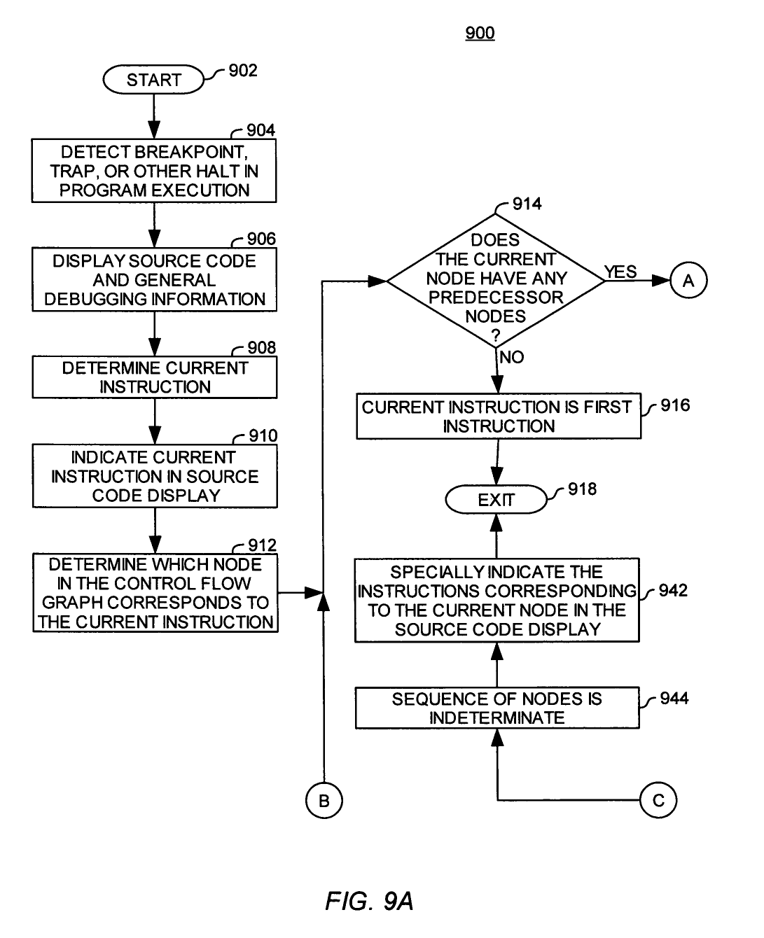

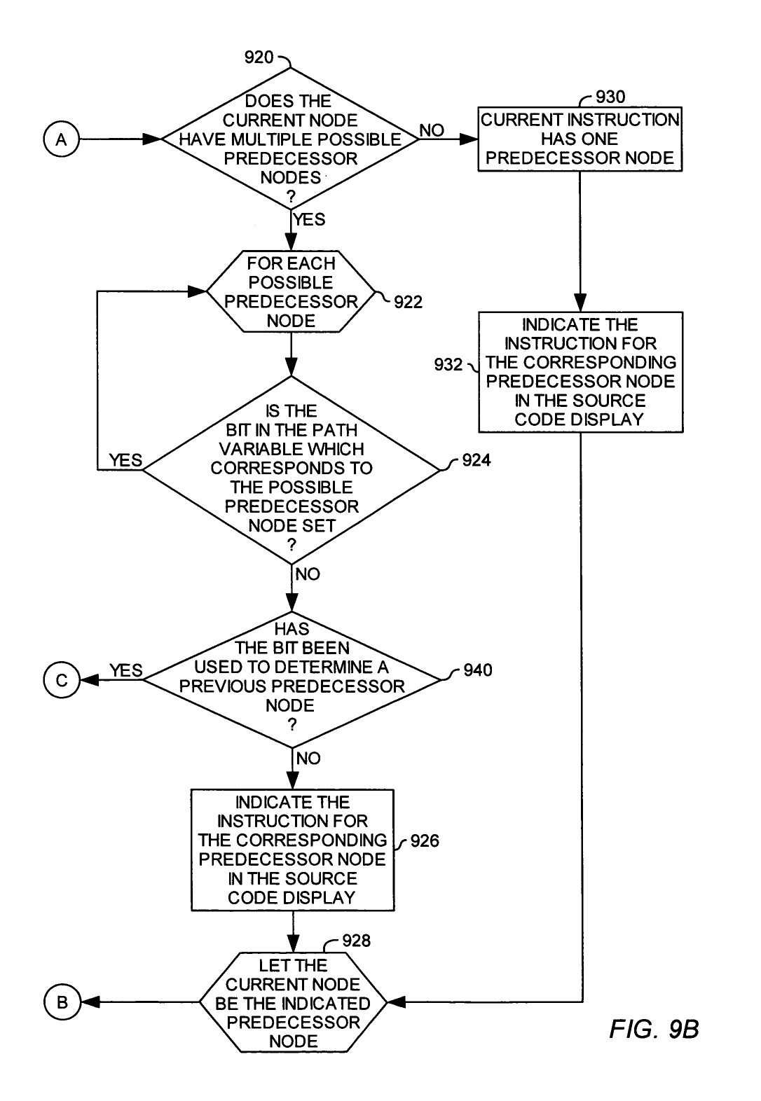

FIGS. 9A and 9B depict a process 900 for displaying the execution path of the program 120 where the execution path may be indeterminate according to one embodiment of the invention. The process 900 may begin at step 902 and continue to step 904 where a breakpoint, trap, or other halt in program execution is detected. When execution of the program 120 halts, control may be passed to the debugger 123 which may be used to process the breakpoint, trap, or other reason for halting program execution.

At step 906, the source code 158 and other general debugging information may be displayed. At step 908, the current instruction may be determined and at step 910, the current instruction may be indicated in the source code display, for example, by highlighting the instruction. Then at step 912, the CFG 354 may be used to determine which node in the CFG 354 corresponds to the current instruction in the program 120 (e.g., the instruction at which program execution halted).

After step 912, the process 900 may enter a loop which continues for each node in the CFG 354. At step 914, a determination may be made of whether the current node has any predecessor nodes. If the current node does not have any predecessor nodes (e.g., like Node A), the current node is the first node in the CFG 354 and the instructions corresponding to the first node may be indicated in the source code display. The process 900 may then terminate. If, however, a determination is made at step 914 that the current node has predecessor nodes, the process 900 may continue at step 920 where a determination is made of whether the current node has multiple possible predecessor nodes. If the current node does not have multiple predecessor nodes, then the current node has one predecessor node (step 930) and the instructions corresponding to the one predecessor node may be indicated in the source code display at step 932. If, however, a determination is made at step 920 that the current node has multiple possible predecessor nodes, a loop may be entered at step 922 which continues for each possible predecessor node.

At step 924 a determination may be made of whether the bit in the path variable which corresponds to the possible predecessor node is set. If the bit corresponding to the predecessor node being examined is not set, the loop may continue by examining the next possible predecessor node at step 922. If, however, the bit in the path variable which corresponds to the possible predecessor node is set, another determination is made at step 940 of whether the bit has been used to determine a previous predecessor node. For example, where the program 120 stops at instruction Z, during a first examination of bits 0 and 1, the bits have not been used to determine an executed predecessor node for Node Z. Accordingly, the bits may be used to determine the most recently executed predecessor node for Node Z and the instructions corresponding to the executed predecessor node may be indicated in the source code display at step 926. Then, at step 928, the current node may become the indicated predecessor node and the process 900 may continue by examining the current node as described above.

When the loop is repeated for Node D, bits 0 and 1 have already been used to determine the predecessor node. Accordingly, at step 940, a determination may be made that the set bit in the path variable has been used to determine a previous predecessor node and that the sequence of nodes prior to the current node (Node D) is indeterminate (step 944). At step 942, the instructions corresponding to the current instruction may be specially indicated in the source code display (e.g., to indicate that the execution path is indeterminate after that node) and the process 900 may then terminate at step 918. In one embodiment, a different icon, a different font, or different highlighting may be used to specially indicate the last node for which the execution path may be determined.

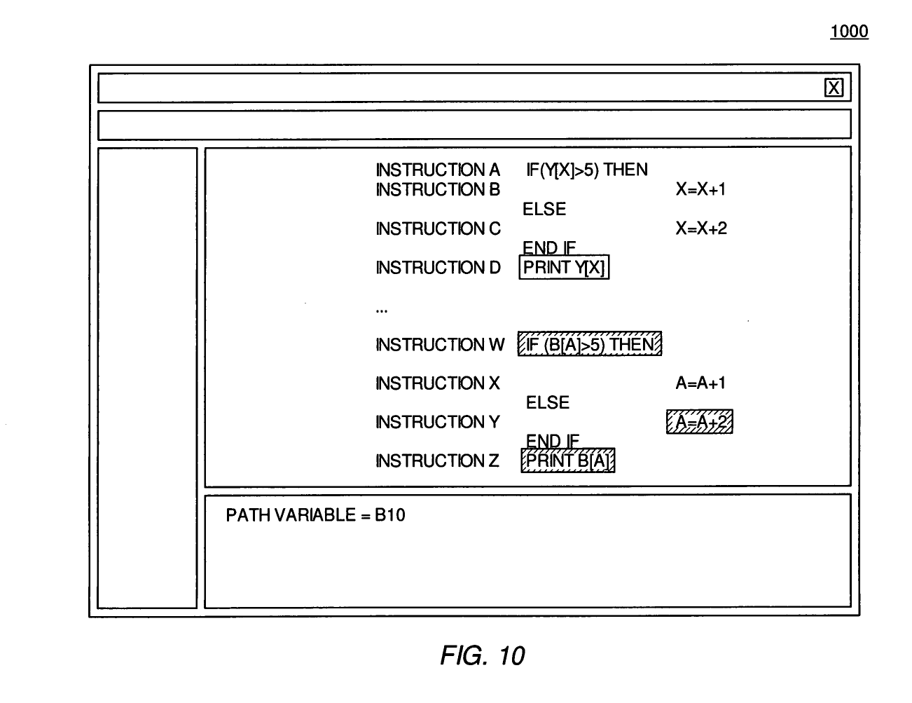

FIG. 10 is a diagram depicting a graphical user interface (GUI 1000) of sample source code 858 according to one embodiment of the invention. The GUI 1000 may result, for example, from process 900. As depicted, a breakpoint may be inserted into the program 120 at Instruction Z (which corresponds to Node Z). When the program 120 halts at instruction I due to the breakpoint, the value of the path variable may be the binary number 10 (as indicated by the statement “Path Variable=b10”).

As depicted, highlighting of executed instructions may be used to identify the execution path of the program 120 in the debugger 123. Because the program 120 has stopped at Node Z, the corresponding instruction(s) for Node Z (Instruction Z) may be highlighted. Also, because bit 1 in the path variable is set, the debugger 123 may determine that Node Y is the executed predecessor node for Node Z. Accordingly, the instruction(s) corresponding to Node Y (Instruction Y) may be highlighted. However, when determining the executed predecessor node for Node D, bits 0 and 1 have already been used to determine the predecessor node for Node Z. Accordingly, the executed predecessor node, and thus the execution path of the program prior to Node D, cannot be determined. Thus, as depicted, Instruction D is specially indicated (with a lighter shade of highlighting), thereby indicating that the execution path prior to that instruction cannot be determined.

As described above, in some cases, a single variable may be allocated to track the execution path of a program (e.g., an integer, a long integer, etc.) and bits in the allocated variable may be reused where the size of the CFG 154 requires more nodes to be tracked than the available number of bits in the allocated variable. Optionally, in one embodiment, multiple variables or a larger amount of memory (e.g., a vector) may be allocated to track the execution path of a program. In some cases, a fixed number of variables or amount of memory may be allocated. Optionally, a number of variables or amount of memory necessary to track the entire execution path of a given program may be allocated. When each of the bits in a given variable or memory location have been used to track executed nodes in the execution path, bits in the next allocated variable or memory location may be used to track remaining nodes in the execution path.

While described herein with respect to statically compiled and bound languages, embodiments described herein can also be applied to dynamically bound languages such as Java without deviating from this invention.

While the foregoing is directed to embodiments of the present invention, other and further embodiments of the invention may be devised without departing from the basic scope thereof, and the scope thereof is determined by the claims that follow.

What is claimed is:

1. A method for tracing an execution path of a program, the method comprising:
creating a control flow graph for the program;
for each node in the control flow graph, determining whether the node has two or more predecessor nodes; and
for each node determined to have two or more predecessor nodes, inserting a set instruction into program code corresponding to the predecessor node which sets a corresponding value of a variable, wherein the corresponding value of the variable indicates that one or more instructions in the predecessor node were executed during an execution of the program.

2. The method of claim 1, further comprising:
executing the program;
stopping execution of the program at a first instruction of the program, wherein the first instruction corresponds to a first node in the control flow graph; and
for each predecessor node of the first node:
determining if a value of the variable is the corresponding value for the predecessor node; and
if the value of the variable is the corresponding value for the predecessor node, indicating that the one or more instructions in the predecessor node are previously executed instructions.

3. The method of claim 1, further comprising, for each of the two or more predecessor nodes:
inserting a clear instruction into the program code corresponding to the predecessor node which clears the corresponding value of the variable for each other predecessor node.

4. The method of claim 3, wherein the corresponding value of the variable is a single bit of the variable.

5. The method of claim 4, wherein the set instruction comprises an OR instruction inserted into code for each of the two or more predecessor nodes.

6. The method of claim 5, wherein the clear instruction comprises an AND instruction inserted into code for each of the two or more predecessor nodes.

7. The method of claim 1, wherein the variable is one of a plurality of variables used to track the execution path of the program.

8. A tangible computer-readable medium containing a program product which, when executed by a processor, performs an operation comprising:
creating a control flow graph for a program;
for each node in the control flow graph, determining whether the node has two or more predecessor nodes; and
for each node determined to have two or more predecessor nodes, inserting a set instruction into program code corresponding to the predecessor node which sets a corresponding value of a variable, wherein the corresponding value of the variable indicates that one or more instructions in the predecessor node were executed during an execution of the program.

9. The computer-readable medium of claim 8, wherein the operation further comprises:
executing the program;
stopping execution of the program at a first instruction of the program, wherein the first instruction corresponds to a first node in the control flow graph; and
for each predecessor node of the first node:
determining if a value of the variable is the corresponding value for the predecessor node; and
if the value of the variable is the corresponding value for the predecessor node, indicating that the one or more instructions in the predecessor node are previously executed instructions.

10. The computer-readable medium of claim 8, wherein the operation further comprises, for each of the two or more predecessor nodes:
inserting a clear instruction into the program code corresponding to the predecessor node which clears the corresponding value of the variable for each other predecessor node.

11. The computer-readable medium of claim 10, wherein the corresponding value of the variable is a single bit of the variable.

12. The computer-readable medium of claim 11, wherein the set instruction comprises an OR instruction inserted into code for each of the two or more predecessor nodes.

13. The computer-readable medium of claim 12, wherein the clear instruction comprises an AND instruction inserted into code for each of the two or more predecessor nodes.

14. The computer-readable medium of claim 8, wherein the variable is one of a plurality of variables used to track the execution path of the program.

15. A system comprising:
a processor; and
a memory containing a program product, which, when executed by the processor, performs an operation comprising:
creating a control flow graph for a program;
for each node in the control flow graph, determining whether the node has two or more predecessor nodes; and
for each node determined to have two or more predecessor nodes, inserting a set instruction into program code corresponding to the predecessor node which sets a corresponding value of a variable, wherein the corresponding value of the variable indicates that one or more instructions in the predecessor node were executed during an execution of the program.

16. The system of claim 15, wherein the operation further comprises:
executing the program;
stopping execution of the program at a first instruction of the program, wherein the first instruction corresponds to a first node in the control flow graph; and
for each predecessor node of the first node:
determining if a value of the variable is the corresponding value for the predecessor node; and
if the value of the variable is the corresponding value for the predecessor node, indicating that the one or more instructions in the predecessor node are previously executed instructions.

17. The system of claim 15, wherein the operation further comprises, for each of the two or more predecessor nodes:
inserting a clear instruction into the program code corresponding to the predecessor node which clears the corresponding value of the variable for each other predecessor node.

18. The system of claim 17, wherein the corresponding value of the variable is a single bit of the variable.

19. The system of claim 18, wherein the set instruction comprises an OR instruction inserted into code for each of the two or more predecessor nodes.

20. The system of claim 19, wherein the clear instruction comprises an AND instruction inserted into code for each of the two or more predecessor nodes.

21. The system of claim 15, wherein the variable is one of a plurality of variables used to track the execution path of the program.
